(19) United States
(12) Patent Application Publication
(10) Pub. No.: US 2014/0300239 A1
(43) Pub. Date: Oct. 9, 2014

(54) SEGMENT COIL, METHOD OF MANUFACTURING SEGMENT COIL, WIRE ROD FOR SEGMENT COIL, AND STATOR

(71) Applicant: TOYOTA JIDOSHA KABUSHIKI KAISHA, Toyota-shi, Aichi-ken (JP)

(72) Inventors: Keiji Takizawa, Toyota-shi (JP); Tomoka Suzuki, Nagakute (JP); Shinichi Iizuka, Osaka-shi (JP); Hironobu Saka, Osaka-shi (JP); Takeshi Ariyoshi, Osaka-shi (JP)

(21) Appl. No.: 14/354,429

(22) PCT Filed: Oct. 22, 2012
(86) PCT No.: PCT/JP2012/077192

§ 371 Date: Apr. 25, 2014

(30) Foreign Application Priority Data
Oct. 27, 2011 (JP) 2011-235979
Nov. 30, 2011 (JP) 2011-262325
Jan. 16, 2012 (JP) 2012-005797
Jan. 30, 2012 (JP) 2012-016236
Feb. 7, 2012 (JP) 2012-023874
Mar. 1, 2012 (JP) 2012-045004
Sep. 10, 2012 (JP) 2012-198626

(51) Int. Cl. H02K 3/28; H02K 15/04

(52) U.S. Cl. CPC H02K 3/28; H02K 15/0414
USPC 310/208; 29/596

(57) ABSTRACT

A segment coil capable of achieving effective prevention of magnetic flux leakage or eddy current and enhancing efficiency of a motor is provided. Segment coils in stator of a rotating electric machine including an annular core and rectangular wire coils in a plurality of layers, which are attached on an innermost circumferential side in a direction of radius of a slot formed in an inner circumferential portion of the annular core and are opposed to a rotor, are each constituted of a plurality of divided wires as divided in a circumferential direction of the annular core. The plurality of divided wires are integrally joined in coil end portions extending from the slot.

### TECHNICAL FIELD

The present application claims priority to Japanese Patent Applications Nos. 2011-235979, 2011-262325, 2012-005797, 2012-016236, 2012-023874, 2012-045004, and 2012-198626 filed on Oct. 27 and Nov. 30, 2011, Jan. 16 and 30, Feb. 7, Mar. 1, and Sep. 10, 2012, respectively, the disclosure of which is incorporated by reference herein in its entirety.

The invention of the present application relates to a segment coil included in a stator of a rotating electric machine, a method of manufacturing a segment coil, a wire rod for a segment coil, and a stator. Specifically, the invention relates to a segment coil capable of achieving less eddy current or magnetic flux leakage caused in a coil accommodated in a stator and a higher space factor.

### BACKGROUND ART

For example, a stator of a motor implemented as a rotating electric machine includes coils in an annular core. In the annular core, a plurality of slots opening on an inner side are provided at prescribed intervals and coils are attached to these slots. A conventional coil has been formed by winding a bendable winding around a slot. It has been difficult, however, to wind the winding around the slot opening on the inner side without causing damage and operability has been poor.

In addition, since a large diameter of a bendable winding cannot be set, a high current cannot flow. Therefore, it is difficult to achieve higher output of a motor. In order to meet the demand for improvement in output and reduction in size of a motor, a space factor of a coil should be enhanced. In a construction in which a winding is wound around, however, a gap is created between windings and an insulating coating layer is provided in each winding. Therefore, a cross-sectional area of a conductor is accordingly decreased and it is also difficult to improve a space factor.

In order to solve the problem above, a technique for forming a coil by attaching to a slot, a plurality of segment coils formed in advance into a form allowing attachment of a coil material having a large cross-sectional area to the slot and connecting through welding, a connection end portion provided in a coil end portion extending from the slot can be adopted. Since a large cross-sectional area can be set by adapting a cross-section of the segment coil to a cross-sectional form of the slot, a high current can flow and a high space factor can be set, to thereby enhance output of a motor.

### CITATION LIST

### Patent Document

PTD 1: Japanese Patent No. 4688003

### SUMMARY OF INVENTION

### Technical Problem

By adopting a segment coil having a large cross-sectional area, a high current can flow and high output can be obtained in a motor. On the other hand, since a cross-sectional area of a coil increases and a current which flows is high, eddy current or magnetic flux leakage is likely in the segment coil.

In particular, magnetic force from a rotor is directly applied to a winding arranged as opposed to the rotor and arranged on an innermost side in a direction of radius, and an area of the winding opposed to a permanent magnet provided in the rotor is large. Therefore, eddy current or magnetic flux leakage is likely. When eddy current or magnetic flux leakage takes place, loss in a motor increases and efficiency will lower.

In a coil including a conventional winding, a technique for alleviating the disadvantages by forming a winding from a plurality of elemental wires and winding the same has been adopted.

In forming a segment coil from a plurality of elemental wires, however, an adhesive layer for bonding an insulating coating layer formed in each elemental wire and each elemental wire should be provided. Therefore, if a segment coil is formed from divided wires, a cross-sectional area of a coil in a slot decreases and a space factor lowers.

In order to form one segment coil by assembling a plurality of bent elemental wires, extremely high working accuracy is required in bending of each elemental wire. In addition, the number of steps for forming a segment coil by assembling each elemental wire increases, which may also lead to significant increase in manufacturing cost.

A segment coil includes an insulating coating layer for insulation between the segment coil and an adjacent segment coil and between the segment coil and a core. The insulating coating layer should be free from partial discharge between members. Partial discharge is likely in a portion where a voltage difference is great. For example, in a case that a segment coil is adopted in a stator of a three-phase AC motor, a voltage difference between segment coils belonging to different phases is greatest. Therefore, partial discharge is likely in a portion where segment coils belonging to different phases are in proximity to or in contact with each other.

In a conventional segment coil, an insulating coating layer capable of accommodating a voltage difference between segment coils belonging to different phases is provided in the entire region of the segment coil so as to prevent partial discharge.

A voltage difference at a site where segment coils belonging to the same phase face each other or at a site where a core and a segment coil face each other is small, and hence it is not necessary to provide an insulating coating layer large in thickness which can accommodate a large voltage difference. Since an insulating coating layer capable of accommodating a voltage difference between coils belonging to different phases has been provided in the entire region of the conventional segment coil, a space factor in a slot has been low, which has led to increase in size of a motor and increase in amount of heat generation.

In order to raise a space factor, it is also possible to employ an expensive insulating material low in relative permittivity and high in insulation performance so as to form an insulating coating layer small in thickness over the entire segment coil, however, it leads to increase in manufacturing cost.

In order to construct a stator, segment coils in a plurality of types of forms are prepared, these segment coils are attached and assembled in a prescribed order to a prescribed slot, and thereafter a connection portion of each segment coil should be connected such that these segment coils constitute an integrated coil.

An operation for attaching and connecting the segment coils, however, is burdensome. In addition, since a large number of segment coils should be assembled while they are close to one another, it is difficult to identify each segment coil and a connection portion to which it should be connected. Therefore, erroneous assembly or erroneous connection is likely.

Furthermore, since segment coils are provided closely to one another, it is difficult also to check erroneous assembly or erroneous connection after assembly or connection, and checking imposes extreme burdens.

A stator including such segment coils is generally formed by arranging a plurality of segment coils as aligned in slots of the stator and thereafter joining end portions of adjacent segment coils through arc-welding.

However, since end portions of segment coils to mutually be joined are joined for each set, operability has been poor. End portions of segment coils to mutually be joined are joined while a pressure is applied thereto in a direction of radius of an annular core, and hence a space in a direction of pressurization is narrow, accuracy in positioning of a jig is strict, and operability is poor.

The invention of the present application aims to provide a segment coil capable of achieving effective prevention of magnetic flux leakage or eddy current and enhancing efficiency of a motor.

The invention of the present application aims to provide a segment coil capable of allowing flow of a high current by setting a large cross-sectional area of a coil and achieving prevention of partial discharge and improved performance of a motor with a space factor being raised.

The invention of the present application aims to provide a segment coil capable of allowing easy identification of a large number of segment coils, attachment to a prescribed slot where each segment coil should be attached, and easy identification and connection of a connection portion to which a segment coil should be connected.

The invention of the present application aims to provide segment coils arranged as aligned in slots of an annular core, capable of achieving efficient joint of adjacent segment coils and effective prevention of deterioration of an insulating film in particular in a coil end portion.

### Solution to Problem

The invention of the present application is directed to a segment coil in a stator of a rotating electric machine including an annular core and rectangular wire coils in a plurality of layers, which is attached on an innermost circumferential side in a direction of radius of a slot formed in an inner circumferential portion of the annular core and opposed to a rotor, the segment coil being formed from a plurality of divided wires as divided in a circumferential direction of the annular core, and the plurality of divided wires being integrally joined in a coil end portion extending from the slot.

Eddy current or magnetic flux leakage in a coil is likely in a segment coil on an innermost side in a direction of radius, which is directly affected by a permanent magnet of a rotor. In the invention of the present application, since a segment coil attached on the innermost side in the direction of radius of the annular core in each slot and opposed to a rotor is formed from a plurality of divided wires, eddy current or magnetic flux leakage can effectively be prevented.

Since a segment coil other than the segment coil arranged on the innermost side in the direction of radius is not formed from divided wires, a cross-sectional area of a coil is not decreased and a high current can flow. Thus, eddy current or magnetic flux leakage can effectively be lessened and a coil through which a high current can flow is obtained.

The divided wires are integrally joined in a coil end portion extending from the slot. As such, it is not necessary to provide an adhesive layer for joint of the divided wires in the slot. Therefore, a large cross-sectional area of each divided wire in the slot can be set and a space factor is also improved.

In addition, since only a segment coil arranged on the innermost side in the direction of radius should be formed from divided wires, there is no significant increase in cost for or the number of processes for manufacturing a stator either.

Eddy current is more likely as an area opposed to a rotor is larger. Therefore, by forming each divided wire to have a rectangular cross-section having a side opposed to the rotor as a short side, eddy current can effectively be prevented.

Preferably, an inner-circumferential-side divided wire including at least a divided wire arranged on the innermost circumferential side with respect to a tooth portion around which the segment coil is wound when viewed from a center in the direction of radius of the stator is formed of a material higher in resistivity than a divided wire arranged on an outer circumferential side.

Eddy current or magnetic flux leakage is more likely in a winding arranged on the outer circumferential side of a tooth portion of a core. As a material is higher in resistivity, eddy current or magnetic flux leakage is less likely. Therefore, by arranging a divided wire formed of a material high in resistivity on the innermost circumferential side facing a tooth portion where eddy current or magnetic flux leakage is likely, eddy current or magnetic flux leakage can effectively be lessened. In the invention of the present application, a segment coil formed from divided wires is attached on the innermost side in the direction of radius of the annular core, as opposed to a rotor. Since an outer surface of each divided wire faces a space where the rotor rotates, temperature increase is less than in a segment coil arranged in an intermediate portion in the direction of radius. Therefore, even when a divided wire on an inner circumferential side is formed of a material high in resistivity and resistance of a segment coil formed from these divided wires is slightly high, it hardly gives rise to a problem.

A divided wire formed of a material high in resistivity can be adopted for an inner-circumferential-side divided wire including at least a divided wire arranged on the innermost circumferential side. For example, in a case that a segment coil is formed from two divided wires, a divided wire on the inner circumferential side arranged adjacently to a tooth portion can be formed of a material higher in resistivity than a material forming a divided wire arranged on the outer circumferential side. In a case that a segment coil is formed from three divided wires, two divided wires on the inner circumferential side arranged on a tooth portion side can be formed of a material higher in resistivity than a material forming a divided wire arranged on the outer circumferential side. Thus, eddy current or magnetic flux leakage in a segment coil formed from divided wires can more effectively be prevented.

A technique for joining divided wires in a coil end portion is not particularly limited and divided wires can be joined with various insulating resin materials. For example, an insulating adhesive, an insulating resin tape material, or an insulating resin tube material can be adopted as the insulating resin material. Alternatively, a tape material or a heat-shrinkable tube material including a tackifier layer can be adopted.

In order to ensure joint strength of each divided wire, the divided wires are preferably joined in a prescribed region in a portion which has not been bent or in a portion bent at a large radius of curvature. For example, preferably, the coil end portion is formed in a mountain shape and the plurality of divided wires are joined in an oblique side portion except for a portion in the vicinity of a peak portion of the mountain shape and portions in the vicinity of opposing mountain-foot portions and/or in a straight portion extending from the slot. For example, in a case that a coil end portion is formed in a mountain shape, a portion in the vicinity of a peak portion of the mountain shape or a portion in the vicinity of a mountain-foot portion of the mountain shape representing transition from an oblique side of the mountain shape to a straight portion accommodated in a slot is bent at a radius of curvature 0.5 to 3 times as high as that for a long side in a rectangular cross-section of each divided wire. An oblique side portion except for the portion in the vicinity of the peak portion of the mountain shape and the portions in the vicinity of opposing mountain-foot portions is bent at a radius of curvature 20 to 60 times as high as that for the long side in the rectangular cross-section of each divided wire. A straight portion extending from a slot is not bent. Therefore, joint in an oblique side portion except for the portion in the vicinity of the peak portion of the mountain shape and the portions in the vicinity of opposing mountain-foot portions and/or in the straight is preferred. It is noted that the oblique side portion can be subjected to prescribed bending along a circumferential direction of a stator. As bending along the circumferential direction, for example, such bending as bending the oblique side portion at one or two or more location(s) to form a substantially polygonal shape or such bending as varying a center of a radius of curvature or a curvature can be performed.

As above, bending is carried out while joint with the insulating resin tape material or the insulating resin tube material is held, and by using the insulating resin tape material or the insulating resin tube material as a joint material, assembly as a segment coil can be carried out. Therefore, the number of manufacturing steps can be decreased and manufacturing cost can be reduced. Alternatively, resin injection molding can also be made use of for joint of divided wires.

Preferably, the segment coil includes a first insulating coating layer formed substantially in the entire region of the coil and a second insulating coating layer formed as stacked at a prescribed site of the first insulating coating layer, and the second insulating coating layer is provided in a portion where segment coils belonging to different phases face each other.

For example, in a three-phase AC motor, a voltage difference between segment coils belonging to different phases is greatest. A voltage difference between a core and a segment coil is smaller than a voltage difference between segment coils belonging to different phases, and in addition, a voltage difference between segment coils belonging to the same phase is further smaller than a voltage difference between the core and the segment coil.

In the invention of the present application, by providing the second insulating coating layer in a portion where segment coils belonging to different phases face each other, a thickness of an insulating coating layer can be different depending on a voltage difference between adjacent coils or between a coil and a core. Partial discharge can thus efficiently be prevented without lowering in reliability. In addition, since an average thickness of an insulating coating layer can be decreased, reduction in weight can also be achieved. Manufacturing cost can also be reduced. The second insulating coating layer can be formed on an inner surface and/or on an outer surface in the direction of radius of the stator of each segment coil. Namely, it can be provided only on a facing surface where adjacent segment coils face each other. As such, a region where a second insulating coating layer is provided can further be reduced.

The second insulating coating layer should only be formed to a thickness allowing prevention of partial discharge based on a voltage difference or positional relation between facing segment coils, and the thickness is not particularly limited.

A technique for forming the first insulating coating layer and the second insulating coating layer is not particularly limited either. For example, each insulating coating layer can be formed with such a technique as powder coating or electrodeposition coating.

A bendable insulating coating layer is preferably provided as the first insulating coating layer. Thus, bending can be performed with the first insulating coating layer having been provided, and thereafter a second insulating coating layer can be provided in a portion where a voltage difference from an adjacent segment coil is large. With this technique, an insulating coating layer different in thickness can readily be formed.

The second insulating coating layer can be formed by using an insulating resin material joining divided wires to each other. Namely, an insulating adhesive, an insulating resin tape material, and an insulating resin tube material adopted as the insulating resin material can implement the second insulating coating layer. The second insulating coating layer can surround the joined divided wires. As such, joint strength of the divided wires can be enhanced by making use of the second insulating coating layer. In using the insulating adhesive, the second insulating coating layer can also be provided in a region including the inner surface and the outer surface in the direction of radius of the stator.

Since segment coils belonging to the same phase are attached to the same slot, it is a coil end portion that segment coils belonging to different phases face each other. Therefore, partial discharge is likely in the coil end portion. Preferably, the coil end portion is formed substantially in a mountain shape having a central portion as a vertex, and in one oblique side portion substantially in the mountain shape of the segment coil, a second insulating coating layer facing the other oblique side portion of a segment coil arranged adjacently to the segment coil is formed.

A segment coil assembled into a stator faces a segment coil adjacent in the direction of radius, in the coil end portion. Then, as a shape of each coil end portion of a segment coil is set substantially like a mountain with a center being defined as the vertex, with respect to one oblique side portion of the mountain shape in one segment coil, the other oblique side portion of the mountain shape in a segment coil adjacent to this one segment coil can face as intersecting the same. Namely, the other oblique side portion of an adjacent segment coil can face one oblique side portion of one segment coil.

As such, the second insulating coating layer can be formed between facing segment coils simply by providing the second insulating coating layer in one oblique side portion of a coil end portion in a mountain shape of each segment coil. Thus, the second insulating coating layer capable of achieving effective prevention of partial discharge can be provided between segment coils facing each other in the coil end portion.

In addition, according to the invention of the present application, the second insulating coating layer can be provided only in a segment coil on one facing side. Therefore, as a whole coil which forms a stator, a region where the second insulating coating layer is provided can be set to be small. Partial discharge can efficiently be prevented, manufacturing cost can be reduced by reducing a material necessary for providing the second insulating coating layer, and a weight of a motor can also be reduced.

In the segment coil, preferably, a colored identification portion is provided on a surface of a prescribed region.

The colored identification portion is an identification label used in a step of assembling a stator, and it can be used for a required assembly operation which is performed with segment coils being identified from each other.

For example, a first colored identification portion allowing identification of a connection portion of a segment coil to be connected can be provided in the connection portion or a portion in the vicinity thereof.

The first colored identification portion is provided for identification of connection portions to be connected to each other and prevention of erroneous connection in a step of connecting a connection portion of each segment coil attached to a prescribed slot of the annular core.

A construction or a form of the first colored identification portion is not particularly limited. For example, colored identification portions of the same color can be provided in connection portions of segment coils to be connected to each other or in the vicinity thereof. A site where a colored identification portion is provided is not particularly limited either, and a colored identification portion can be provided in a connection portion or in the vicinity thereof so as to allow identification of a connection portion during a connection operation.

By forming a first colored identification portion at a site allowing external identification after end of assembly, image recognition of the first colored identification portion is allowed so that whether connection is erroneous or not can be checked.

In a case that a first colored identification portion is provided in a connection portion, it is desirably formed at a site other than a connection surface. For example, the first colored identification portion is formed on a coil end surface of the connection portion.

The coil end surface is a site which can reliably visually be recognized from the outside of the stator. By providing the first colored identification portion on the coil end surface, connection portions of segment coils to be connected to each other can reliably be identified for a connection operation. After assembly ends, a CCD camera can also be used to zoom in the connection portion for inspection. Automatic inspection can also be conducted through image recognition.

The technique for forming the colored identification portion is not particularly limited. For example, the first colored identification portion can be formed by applying a color paint or bonding a color tape material.

Various resin paints can be used as a color paint. Color tape materials formed of various materials can be adopted as the color tape material. Preferably, a color tape material having a tackifier layer or an adhesive layer is adopted. In a case that a first colored identification portion is provided on a coil end surface, an end surface of each coil is preferably worked to be flat.

The first colored identification portion can be formed by providing a color cap in the coil end portion. Since a conductor is exposed in a connection portion as a result of removal of an insulating coating layer, a function to protect an exposed conductor surface can also be exhibited by providing a color cap.

The color cap can be formed to allow removal before connection, by forming the color cap so as to cover the entire connection portion, or it can also be formed to cover a site other than the connection surface for allowing a connection operation while it is attached.

A material for forming the color cap is not particularly limited, and a color cap obtained by molding various colored resin materials or a color cap formed of a metal material and subjected to coloring can be adopted.

As the colored identification portion, a second colored identification portion formed to allow identification of a slot to which each segment coil is to be attached and/or a position of disposition in the slot can be provided. The second colored identification portion is provided on a surface of the segment coil other than the connection portion, separately from the first colored identification portion.

The second colored identification portion can be used for attachment of a prescribed segment coil to a prescribed slot or for identification of a position of disposition of a segment coil attached to each slot in a step of attaching a plurality of types of segment coils to a core.

By providing a second colored identification portion, a prescribed segment coil can readily be attached to a prescribed slot. In addition, an order of disposition in each slot can readily be checked. It is noted that a second colored identification portion provided for attachment of a prescribed segment coil to a prescribed slot and a second colored identification portion for identification of an order of disposition in each slot can be formed such that their roles are combined, or they can also be provided as independent colored identification portions at different sites.

The second colored identification portion provided for attachment of a prescribed segment coil to a prescribed slot can be formed, for example, to have the same color for each slot for accommodation. In order to recognize a position of disposition of segment coils attached to each slot, for example, second colored identification portions colored in the same color such that density is varied in the order of disposition can be provided.

A construction or a form of the second colored identification portion is not particularly limited either. The second colored identification portion can be provided by applying a color paint, bonding a color tape material, or attaching a color tube material to a prescribed region of the segment coil. The second colored identification portion can be provided by coloring the entire or partial region of the coil end portion. The second colored identification portion should only be provided at least in the coil end portion. The second colored identification portion can also be provided by coloring the entire insulating coating layer of each segment coil.

The second colored identification portion can be provided as a second insulating coating layer preventing partial discharge against an adjacently arranged segment coil.

Since segment coils belonging to different phases are disposed in proximity to or in contact with each other in a coil end portion, partial discharge is likely between these coils. If partial discharge takes place, an insulating coating layer is damaged and short-circuiting may occur between coils. As the second colored identification portion serves also as the second insulating coating layer capable of preventing partial discharge, not only an operation for assembling a stator can be facilitated but also reliability of a stator can be improved.

A construction or a form of the second colored identification portion for prevention of partial discharge is not particularly limited. In order to effectively prevent partial discharge, for example, a required partial discharge voltage can be ensured by applying a paint composed of an insulating resin to a thickness from 20 to 200 μm. When a thickness is not greater than 20 μm, partial discharge may be likely between proximate coils and required strength of a film cannot be ensured. When a thickness is equal to or greater than 200 μm, it becomes difficult to ensure a space for attaching a coil.

A second colored identification portion also serving as a second insulating coating layer can be formed by employing an insulating resin tape material or an insulating resin tube material. As a color tape material having a partial discharge prevention effect, an insulating resin tape material manufactured by Permacel (trade name Kapton tape) can be adopted. An insulating resin tube material manufactured by Sumitomo Electric Industries, Ltd. (trade name Sumitube) can be adopted as a color tube material.

Preferably, the segment coil is constructed such that a connection portion has a joint surface for connection to another segment coil provided at a tip end portion thereof, and the connection portion is constructed such that the joint surface is in parallel to the direction of radius of the stator. So long as the joint surface is provided, a form of the joint portion and a technique for forming the same are not limited. For example, the joint surface can be formed by forging a coil tip end portion or subjecting the coil tip end portion to plastic forming such as twisting.

Since the joint surface is in parallel to a direction of radius of the annular core, when a plurality of segment coils are arranged as aligned in an annular core, a direction of pressurization of a joint surface can be set to a circumferential direction of the annular core. Thus, a space (a gap) formed between adjacent slots can effectively be made use of for joint of a joint portion. Therefore, a sufficient space can be secured in the direction of pressurization of the joint surface and operability in a joint step of joint portions can be improved. Efficient joint of adjacent segment coils can be realized. In addition, by setting the joint surface to be in parallel to the direction of radius of the annular core, when a plurality of segment coils are arranged as aligned in the annular core, a space (a gap) formed between adjacent slots can effectively be increased and a stator having a good heat dissipation property can be formed.

The segment coil can be constructed such that adjacent joint portions are arranged as displaced between an inner diameter side and an outer diameter side in a direction of radius of the annular core when the segment coils are arranged as aligned in the slots of the annular core.

By providing such a joint portion, simply by arranging a plurality of segment coils as aligned in the annular core, a plurality of segment coils arranged in the same slot can be arranged while joint surfaces to mutually be joined are opposed to each other. Since the joint surface is in parallel to the direction of radius of the annular core, the joint surfaces of a plurality of sets of joint portions to mutually be joined can be arranged in a line in the direction of radius of the annular core. As such, joint of the plurality of sets of joint portions can simultaneously be carried out. Therefore, multi-point simultaneous joint of the plurality of sets of joint portions can be realized. Thus, operability in the joint step can be improved and efficient joint of adjacent segment coils can be realized.

The segment coil according to the invention of the present application can be manufactured by including a bundling step of joining a plurality of elemental wires implementing the divided wires with a tape material or a tube material at a site of formation of a coil end portion and a bending step of integrally bending the integrated elemental wires at a site other than a site of joint.

If a plurality of divided wires are separately bent, the number of steps significantly increases. In addition, since the divided wires are integrally joined, very high dimension accuracy is required in separately bending each divided wire.

By integrally bending a plurality of elemental wires bundled in advance with a tape material, the number of steps for a segment coil formed from divided wires can significantly be decreased.

If bending at a site where a tape material or a tube material is provided is carried out, the tape material may be damaged or bundling force may lower. Therefore, the integrated elemental wires are preferably integrally bent at a site other than the site of bundling.

The tape material is not particularly limited so long as bundled elemental wires can be bent. For example, in the bundling step, after segment coils formed from divided wires are bundled with the use of the tape material or the tube material formed of an insulating resin and bent, they can also be assembled as they are into the annular core. The segment coil can thus be formed with divided wires having been bundled and joined with the tape material or the tube material.

In a case that a tape material for bending is adopted, a joint step of joining the divided wires with an adhesive in the coil end portion can be included after the bending step. In this case, a step of removing the tape material can also be performed.

The segment coil according to the invention of the present application can be formed from a wire rod for a segment coil in which a plurality of divided wires are integrally joined with the use of an insulating resin material in a portion to serve as a coil end portion.

An insulating adhesive, an insulating resin tape material, or an insulating resin tube material can be adopted as the insulating resin material.

As the wire rod, a wire rod having an insulating coating layer around an outer perimeter except for connection portions provided in opposing end portions and including a colored identification portion on an end surface thereof in a connection portion and/or on a surface in a prescribed region of the insulating coating layer can be adopted.

The segment coil according to the invention of the present application can be applied to stators in various forms.

The stator can be formed through solid-phase welding of joint portions of adjacent segment coils.

With solid-phase welding of joint portions of adjacent segment coils, a stator can be high in manufacturing efficiency. Since an amount of heat generation is small in solid-phase welding, thermal influence is also less. Therefore, a conductor or an insulating coating material low in heat resistance and inexpensive can be employed.

For example, by adopting ultrasonic welding as solid-phase welding, a stator can further be higher in manufacturing efficiency.

### Advantageous Effects of Invention

A stator capable of achieving effective prevention of eddy current or magnetic flux leakage can be obtained.

### BRIEF DESCRIPTION OF DRAWINGS

FIG. 1 is a perspective view of a main portion showing a state that segment coils are assembled into a core of a stator.

FIG. 2 is a partial perspective view schematically showing a form of the segment coils shown in FIG. 1.

FIG. 3 is a cross-sectional view along the line III-III in FIG. 1.

FIG. 4A is a cross-sectional view showing an example of a form of division of a segment coil.

FIG. 4B is a cross-sectional view showing an example of a form of division of a segment coil.

FIG. 4C is a cross-sectional view showing an example of a form of division of a segment coil.

FIG. 4D is a cross-sectional view showing an example of a form of division of a segment coil.

FIG. 5A is a diagram showing a procedure for manufacturing a segment coil.

FIG. 5B is a diagram showing the procedure for manufacturing a segment coil.

FIG. 5C is a diagram showing the procedure for manufacturing a segment coil.

FIG. 5D is a diagram showing the procedure for manufacturing a segment coil.

FIG. 6 is a front view showing a second embodiment of a segment coil.

FIG. 7 is a front view of a main portion showing a state of facing between one segment coil and a segment coil arranged adjacently thereto.

FIG. 8 is a cross-sectional view along the line VIII-VIII in FIG. 7.

FIG. 9 is a cross-sectional view along the line IX-IX in FIG. 8.

FIG. 10 is a diagram showing a second example of a second insulating coating layer and a cross-sectional view corresponding to FIG. 9.

FIG. 11 is an enlarged perspective view of segment coil connection portions of a stator including segment coils according to a third embodiment of the invention of the present application.

FIG. 12 is an enlarged perspective view of the connection portions of the segment coils shown in FIG. 11.

FIG. 13 is a front view showing a segment coil according to a variation of the third embodiment.

FIG. 14 is a right side view along the line XIV-XIV in FIG. 13.

FIG. 15 is a cross-sectional view along the line XV-XV in FIG. 13.

FIG. 16A is a diagram showing a segment coil according to a fourth embodiment and a perspective view of the segment coil.

FIG. 16B is a diagram showing the segment coils according to the fourth embodiment and a diagram showing in a simplified manner, a main portion when the segment coils assembled into an annular core is viewed from the outside of the annular core.

FIG. 17A is a diagram showing the segment coil according to the fourth embodiment and a perspective view of the segment coil.

FIG. 17B is a diagram showing the segment coil according to the fourth embodiment and a side view of the segment coil.

FIG. 18 is a diagram showing a main portion of a segment coil according to a variation of the fourth embodiment.

FIG. 19 is a diagram schematically showing a state that joint portions are joined after the segment coils according to the fourth embodiment are assembled into the annular core.

FIG. 20A is a diagram schematically showing the segment coils arranged in adjacent slots while the segment coils according to the fourth embodiment are assembled into the annular core and a diagram showing the segment coils according to the embodiment of the present invention.

FIG. 20B is a diagram schematically showing the segment coils arranged in adjacent slots while the segment coils according to the fourth embodiment are assembled into the annular core and a diagram showing segment coils according to a first comparative example.

FIG. 20C is a diagram schematically showing the segment coils arranged in adjacent slots while the segment coils according to the fourth embodiment are assembled into the annular core and a diagram showing segment coils according to a second comparative example.

FIG. 21A is a diagram showing in a simplified manner, a state that segment coils according to a fifth embodiment are arranged as aligned in the same slot and a perspective view showing the segment coils.

FIG. 21B is a diagram showing in a simplified manner, a state that the segment coils according to the fifth embodiment are arranged as aligned in the same slot and a diagram schematically showing a main portion of a side surface of the segment coils.

### DESCRIPTION OF EMBODIMENTS

An embodiment of the invention of the present application will specifically be described hereinafter with reference to the drawings.

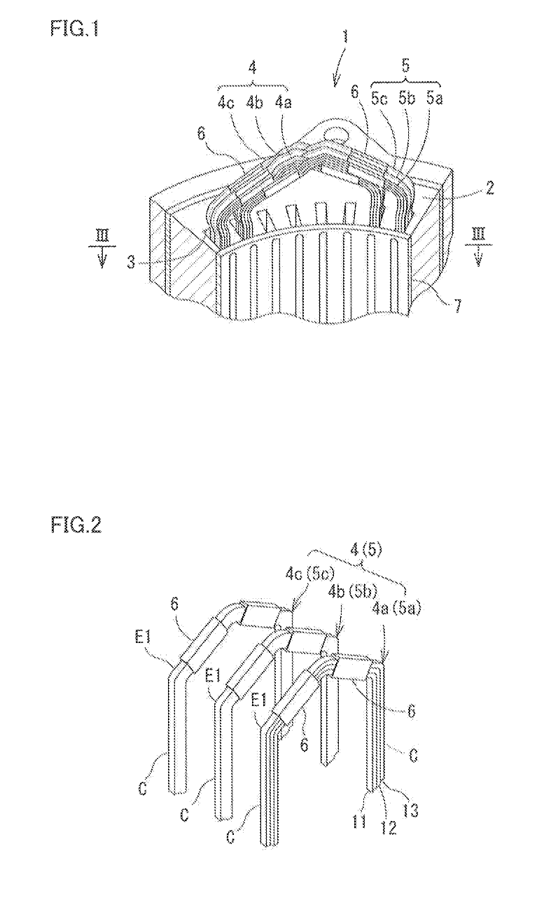

FIG. 1 is a perspective view of a main portion showing a state that segment coils 4 and 5 according to the invention of the present application are attached to an annular core 2 of a stator. FIG. 2 is a partial perspective view showing one form of segment coils 4 and 5 according to the invention of the present application.

Annular core 2 has a thick annular structure formed of a magnetic material, and slots 3 each penetrating in an axial direction through an inner circumferential portion and opening in an inner circumferential surface are formed at prescribed intervals. For facilitating understanding, in the present embodiment, a state that segment coils 4 and 5 are attached to some of slots 3 is shown.

Slot 3 is formed substantially in correspondence with a width of segment coil 4, 5, and segment coils 4 and 5 are assembled into annular core 2 by accommodating a straight portion C of segment coil 4, 5 in slot 3.

A material forming annular core 2 is not particularly limited. For example, a core formed by compacting magnetic powders or a core formed by stacking magnetic steel plates can be adopted.

For example, in a three-phase induction motor, a plurality of segment coils categorized into a U-phase, a V-phase, and a W-phase are assembled into slots at prescribed intervals.

As shown in FIG. 2, segment coils 4 and 5 each include a pair of straight portions C accommodated in slots 3 and a pair of coil end portions E1 extending from opposing end portions in an axial direction of slot 3 and having a mountain shape. A not-shown lower coil end portion is bent in accordance with a not-shown required pattern and it includes a connection portion for connection to an adjacent segment coil.

In segment coil 4, 5, a first insulating coating layer is formed around the entire outer perimeter except for the connection portion such that insulation from an adjacent segment coil or a core can be ensured.

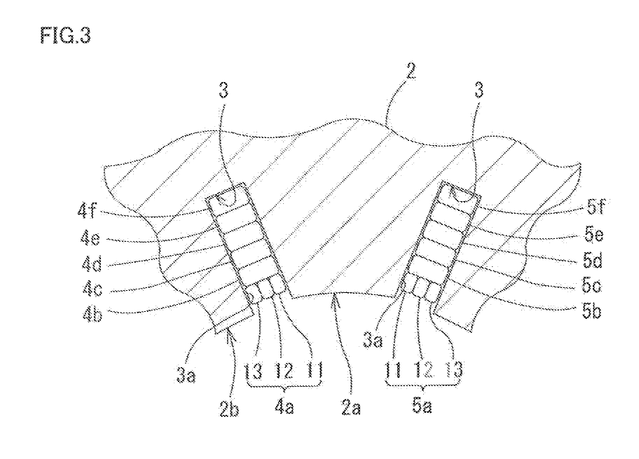

As shown in FIGS. 2 and 3, in the present embodiment, segment coils are disposed in a plurality of layers in a direction of radius in slot 3 formed in an inner circumferential portion of annular core 2 and a segment coil 4a, 5a attached on an innermost side in a direction of radius of slot 3 and opposed to a rotor includes three divided wires 11, 12, and 13 as divided in a circumferential direction of slot 3. FIG. 3 shows a state that segment coils 4a to 4f and 5a to 5f are attached to the entire region of slot 3.

Eddy current or magnetic flux leakage is likely in a segment coil on the innermost side in the direction of radius of annular core 2, which is directly affected by a permanent magnet in a rotor. In the invention of the present application, since segment coils 4a and 5a attached on the innermost side in the direction of radius of slot 3 and opposed to the rotor are formed from a plurality of divided wires 11, 12, and 13, eddy current or magnetic flux leakage can effectively be prevented.

Since segment coils 4b, 4c, Sb, and Sc other than segment coils 4a and 5a arranged on the innermost side in the direction of radius are not formed from divided wires, a high current can flow therethrough without decrease in cross-sectional area of a coil. Therefore, a coil capable of achieving effectively lessened eddy current or magnetic flux leakage and allowing a flow of a high current can be obtained.

In the present embodiment, divided wires 11, 12, and 13 are integrally bundled and joined with an insulating resin tape material or insulating resin tube material 6 in coil end portion E1 extending from slot 3. As such, it is not necessary to provide an adhesive layer for joint of divided wires 11, 12, and 13 in slot 3. Therefore, a large cross-sectional area of each divided wire 11, 12, 13 in slot 3 can be set and a space factor can also be enhanced.

Various materials can be adopted for insulating resin tape material or insulating resin tube material 6. For example, a heat-shrinkable tube such as an insulating resin tube material (trade name Sumitube) manufactured by Sumitomo Electric Industries, Ltd. or an insulating resin tape material (trade name Kapton tape) manufactured by Permacel can be adopted.

It is noted that divided wires can also be joined with an adhesive without using insulating resin tape material or insulating resin tube material 6. An insulating resin adhesive such as an epoxy resin can be adopted as the adhesive. Alternatively, divided wires can also be joined through resin injection molding.

In the present embodiment, insulating resin tape material or insulating resin tube material 6 forms a second insulating coating layer for segment coils 4b and 5b arranged on an outer side in the direction of radius of the stator. Namely, by arranging insulating resin tape material or insulating resin tube material 6 such that a large distance between adjacent or proximate coils can be set in coil end portion E1, it can function as the second insulating coating layer preventing partial discharge between these coils. As a material allowing a function as the second insulating coating layer preventing partial discharge, not only an electrically insulating resin material but also an adhesive, a tape material, and a tube material formed of a semiconductive material can be adopted.

In the present embodiment, since only segment coils 4a and 5a arranged on the innermost side in the direction of radius are formed from divided wires, manufacturing cost or the number of manufacturing steps does not significantly increase either.

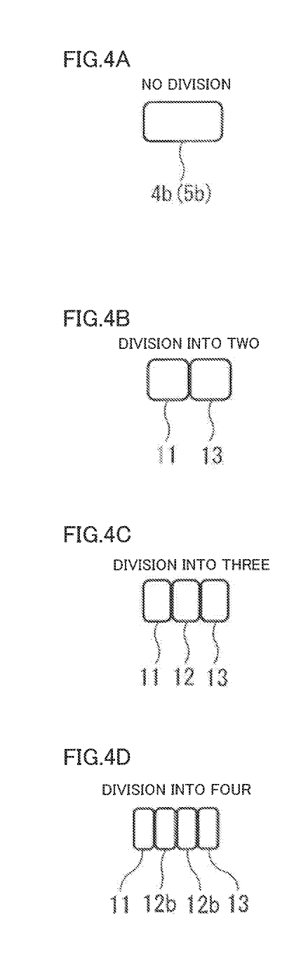

A form of division of divided wires forming segment coils 4a and 5a is not particularly limited either. For example, such a form that a segment coil having a rectangular cross-section shown in FIG. 4A is divided into two as shown in FIG. 4B, into three as shown in FIG. 4C, or into four as shown in FIG. 4D can be adopted.

Eddy current in a segment coil is more likely as an area opposed to a rotor is greater. Therefore, as shown in FIG. 4C or 4D, divided wires 11, 12, 13, 12b, and 12b are each preferably formed to have a rectangular cross-section having a side opposed to the rotor as a short side.

Eddy current or magnetic flux leakage is likely also in a portion opposed to a wall surface 3a, of each tooth portion 2a around which each segment coil 4a, 5a is wound. In the invention of the present application, since segment coils 4a and 5a are formed from two or more divided wires shown in FIGS. 3 and 4B to 4D, eddy current or magnetic flux leakage is more likely in divided wire 11 on the innermost circumferential side with respect to each tooth portion 2a around which segment coil 4a, 5a is wound, when viewed from a center in the direction of radius of the stator.

In order to avoid such a disadvantage, in a segment coil formed from a plurality of divided wires, an inner-circumferential-side divided wire including at least divided wire 11 arranged on the innermost circumferential side with respect to tooth portion 2a around which the divided wire is wound when viewed from the center in the direction of radius of the stator can be formed of a material higher in resistivity than divided wire 13 arranged on the outer circumferential side. For example, in the embodiment shown in FIG. 3, divided wire 11 arranged on the innermost circumferential side with respect to each tooth portion 2a, 2b can be formed of a material higher in resistivity than a material forming divided wires 12 and 13 arranged on the outer circumferential side.

A material higher in resistivity is less likely to cause eddy current or magnetic flux leakage. Therefore, by arranging a divided wire formed of a material high in resistivity on the innermost circumferential side adjacent to tooth portion 2a where eddy current or magnetic flux leakage is likely, eddy current or magnetic flux leakage can effectively be lessened. In the invention of the present application, a segment coil formed from divided wires is attached on the innermost side in the direction of radius of the annular core as opposed to the rotor. Since an outer surface of each divided wire faces a space where the rotor rotates, temperature increase is less than in a segment coil arranged in an intermediate portion in the direction of radius. Therefore, even when a divided wire on the inner circumferential side is formed of a material high in resistivity and resistance of a segment coil formed from such divided wires is slightly high, it hardly gives rise to a problem.

A divided wire formed of a material high in resistivity can be adopted as an inner-circumferential-side divided wire including at least divided wire 11 arranged on the innermost circumferential side. For example, when a segment coil is formed from two divided wires 11 and 13 as shown in FIG. 4B, divided wire 11 on the inner circumferential side arranged adjacent to tooth portion 2a can be formed of a material higher in resistivity than a material forming divided wire 13 arranged on the outer circumferential side. Alternatively, when a segment coil is formed from three divided wires 11, 12, and 13 as shown in FIG. 4C, two divided wires 11 and 12 on the inner circumferential side arranged on a tooth portion side can be formed of a material higher in resistivity than a material forming divided wire 13 arranged on the outer circumferential side. Thus, eddy current or magnetic flux leakage in a segment coil formed from divided wires can more effectively be prevented.

Segment coils 4a and 5a can be manufactured with various techniques. For example, segment coils 4a and 5a can be manufactured by combining separately bent divided wires and integrally joining them with insulating resin tape material 6 or an adhesive described above. In separately bending each divided wire 11, 12, 13, however, very high working accuracy is required and the number of assembly steps increases.

In order to avoid such a disadvantage, bending is preferably carried out after elemental wires 11a, 12a, and 13a implementing divided wires are assembled.

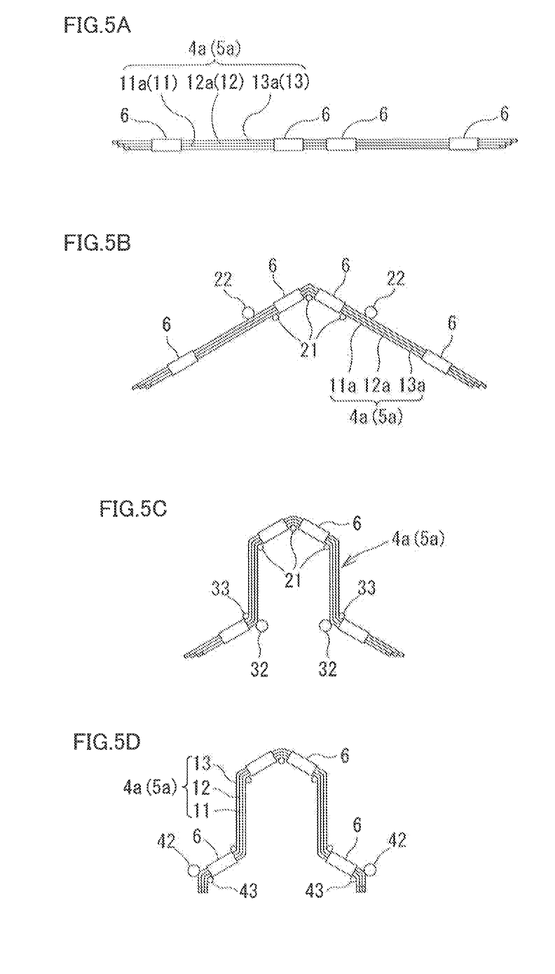

FIGS. 5A to 5D show one embodiment of a method of manufacturing a segment coil.

As shown in FIG. 5A, elemental wires 11a, 12a, and 13a cut to a prescribed length corresponding to divided wires 11, 12, and 13 are bundled with insulating resin tape material 6. Bundling is performed in a portion not bent or in a region bent at a high radius of curvature. For example, a plurality of elemental wires 11a, 12a, and 13a can be joined in a region to serve as an oblique side portion except for a portion in the vicinity of a peak portion of a mountain shape and portions in the vicinity of opposing mountain-foot portions and in a region to serve as straight portion C extending from the slot as in the segment coil in FIG. 2. In a case that coil end portion E1 is formed in a mountain shape, the portion in the vicinity of the peak portion of the mountain shape or the portion in the vicinity of the mountain-foot portion of the mountain shape representing transition from an oblique side of the mountain shape to straight portion C accommodated in slot 3 is bent at a radius of curvature 0.5 to 3 times as high as that for a long side in a rectangular cross-section of each divided wire. The oblique side portion except for the portion in the vicinity of the peak portion of the mountain shape and the portions in the vicinity of the opposing mountain-foot portions is bent at a radius of curvature 20 to 60 times as high as that for a long side in the rectangular cross-section of each divided wire. Straight portion C extending from the slot is not bent. Therefore, bundling is preferably performed in the oblique side portion except for the portion in the vicinity of the peak portion of the mountain shape and the portions in the vicinity of the opposing mountain-foot portions and/or in the region to serve as straight portion C. Though not shown, the oblique side portion is subjected to prescribed bending along the circumferential direction of the stator. A form of prescribed bending along the circumferential direction of the stator is not particularly limited. For example, such bending as bending the oblique side portion at one or two or more location(s) to form a substantially polygonal shape or such bending as varying a center of a radius of curvature or a curvature can be performed.

Then, as shown in FIG. 5B, bending jigs 21 and 22 are applied to bundled elemental wires for bending in a central portion of the elemental wire.

As shown in FIG. 5C, bending of an intermediate portion of the elemental wires is performed with the use of bending jigs 32 and 33, and as shown further in FIG. 5D, an end portion of the elemental wires is bent with the use of bending jigs 42 and 43.

Since elemental wires 11a, 12a, and 13a are bundled with insulating resin tape material 6, facing surfaces thereof can slide against each other and three elemental wires 11a, 12a, and 13a can integrally be bent.

Since insulating resin tape material 6 bundles elemental wires 11a, 12a, and 13a at a site which is not bent or at a site where a radius of curvature of bending is large, insulating resin tape material 6 is not damaged.

By integrally bending bundled three elemental wires 11a, 12a, and 13a, a segment coil bundled and joined with insulating resin tape material 6 can be formed.

A tape material for bending can also be adopted instead of insulating resin tape material 6 and divided wires can also be joined with the use of an adhesive in coil end portion E1 after bending. In this case, a tape material for working may be removed as necessary or remain adhered as it is.

By adopting the manufacturing technique above, the number of steps for segment coils formed from divided wires can significantly be decreased.

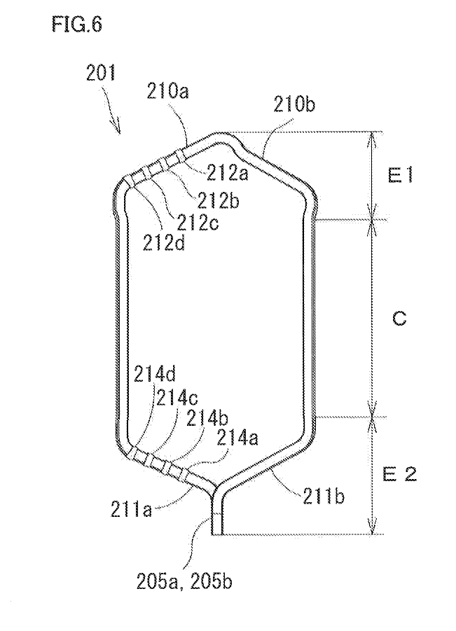

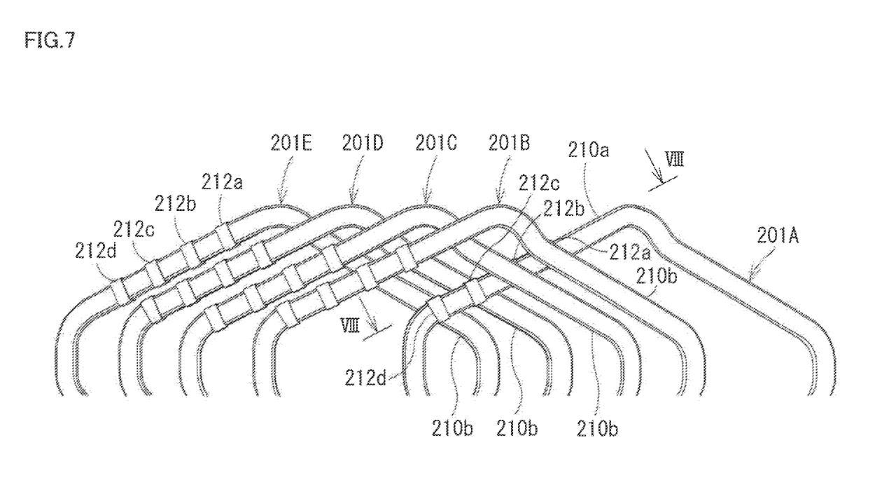

FIGS. 6 to 10 show a second embodiment of the invention of the present application. A segment coil 201 according to the present embodiment is constituted of three divided wires as in the first embodiment, although not shown.

As shown in FIG. 6, segment coil 201 in a representative form attached to each slot 3 of stator 1 as shown in FIG. 1 is formed substantially in a hexagonal shape including a pair of straight portions C accommodated in slot 3 and a pair of coil end portions E1 and E2 extending from opposing end portions in an axial direction of slot 3 and having a mountain shape. In coil end portion E2, adjacent segment coils attached to the same slot 3 are connected and connection to a segment coil attached to another slot is also made. For connection to a segment coil attached to another slot, segment coils attached on an innermost side and an outermost side in a direction of radius of the stator are provided with coil end portions in a plurality of forms in accordance with a connection pattern. The description below is given for segment coil 201 in a form shown in FIG. 6 for facilitating understanding.

One coil end portion E1 is formed in a mountain shape which connects in a bridging manner, a pair of straight portions C accommodated in prescribed slot 3. The other coil end portion E2 is provided with connection portions 205a and 205b for connection to a segment coil adjacently accommodated in slot 3 and a mountain shape is formed in cooperation with a coil end portion of a connected segment coil.

As shown in FIGS. 7 and 9, in segment coils 201A to 201E, a first insulating coating layer 207 is formed around the entire outer perimeter except for connection portions 205a and 205b of a conductive rectangular coil material 206 having a rectangular cross-section. First insulating coating layer 207 is formed to an even thickness over the entire outer perimeter of a coil material 206 to a thickness from 5 to 25 μm with the use of a material resistant to bending such as polyimide.

As shown in FIG. 6, in one oblique side portion 210a, 211a of coil end portion E1, E2 formed in the mountain shape in segment coil 201 according to the present embodiment, second insulating coating layers 212a, 212b, 212c, 212d, 214a, 214b, 214c, and 214d are formed. It is noted that an oblique side portion where a second insulating coating layer is to be provided may be oblique side portions 210b and 211b on the opposite side. A second insulating coating layer may be provided in different oblique side portions in upper and lower coil end portions E1 and E2. It is noted that a second insulating coating layer is provided in an oblique side portion on the same side of each segment coil in one coil end portion. The second insulating coating layer is preferably formed in a prescribed region in a portion not bent or a portion bent at a large radius of curvature. For example, it is preferably formed in the oblique side portion except for the portion in the vicinity of the peak portion of the mountain shape and the portions in the vicinity of the opposing mountain-foot portions.

As shown in FIG. 9, second insulating coating layers 212a, 212b, 212c, 212d, 214a, 214b, 214c, and 214d according to the present embodiment are formed by applying in stack an insulating polyamide imide resin paint material on first insulating coating layer 207 around the entire perimeter of a prescribed width to a prescribed thickness. Though a thickness of second insulating coating layers 212a, 212b, 212c, 212d, 214a, 214b, 214c, and 214d is not particularly limited, for example, they can be formed to a thickness from 50 to 200 μm depending on a voltage difference between segment coils facing each other.

In the present embodiment, among coils which form phases of a three-phase AC motor, four coils are disposed in a state abutting to or proximate to oblique side portions 210a and 210b in the mountain shape in coil end portions E1 and E2 of segment coils 201A to 201E including segment coils arranged on the innermost circumferential side and on the outermost circumferential side in the direction of radius of stator 1 shown in FIG. 1.

FIG. 7 is a front view schematically representing one segment coil 201A and segment coils 201B, 201C, 201D, and 201E facing one oblique side portion 210a of this segment coil 201A as extracted.

As shown in this figure, respective right oblique side portions 210b of four adjacent segment coils 201B, 201C, 201D, and 201E face left oblique side portion 210a in the figure of one segment coil 201A, as intersecting at prescribed intervals.

In the present embodiment, in left oblique side portion 210a of one segment coil 201A, second insulating coating layers 212a to 212d are formed in a portion which other segment coils 201B, 201C, 201D, and 201E face.

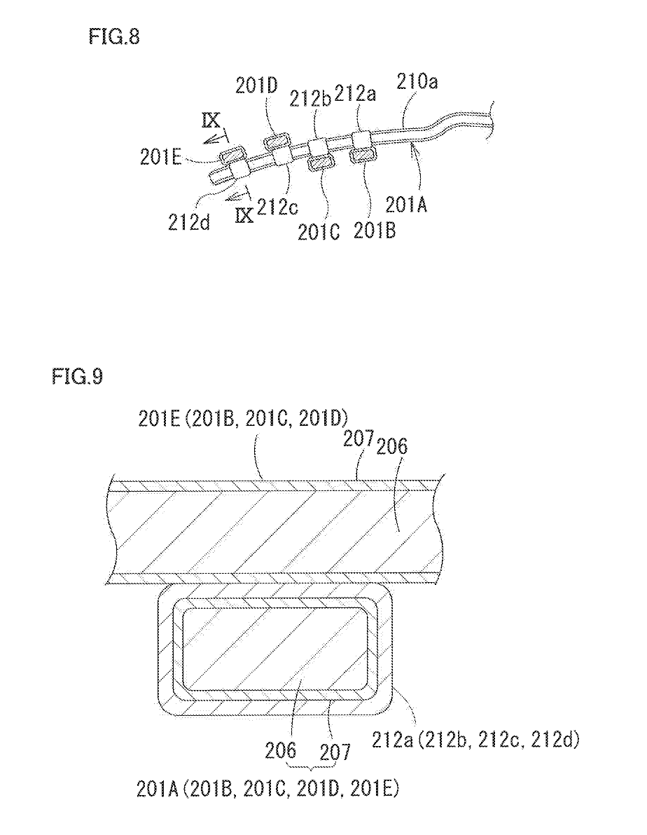

FIG. 8 is a cross-sectional view along the line VIII-VIII in FIG. 7. As shown in FIG. 8, in the present embodiment, second insulating coating layers 212a, 212b, 212c, and 212d are provided in left oblique side portion 210a of coil end portion E1, E2 in the mountain shape of each segment coil. Second insulating coating layers 212a, 212b, 212c, and 212d expand a gap from facing segment coils 201B, 201C, 201D, and 201E so that partial discharge between segment coils facing each other in coil end portion E1 can be prevented.

Furthermore, second insulating coating layers 212a to 212d are provided only in segment coil 201A, on one facing side. Therefore, in a whole coil forming a stator, a region where second insulating coating layers 212a to 212d are provided can be small. Partial discharge can efficiently be prevented and a material necessary for providing second insulating coating layers 212a to 212d can be reduced, to thereby reduce manufacturing cost. In addition, a weight of a motor can also be reduced.

Since no second insulating coating layer is formed in a portion accommodated in slot 3, a large cross-sectional area of a conductor in slot 3 can be set. Therefore, a space factor in slot 3 can be improved and efficiency of a motor can be enhanced.

An adjacent segment coil is arranged only on one side in the direction of radius of segment coils arranged on the outermost side and on the innermost side in the direction of radius of the stator, respectively, and a segment coil is coupled to a segment coil of the same phase attached to another slot. Therefore, depending on design, a portion to face an adjacent segment coil is different. Therefore, a second insulating coating layer should only be provided in a portion facing another segment coil, depending on a construction of a segment coil in stator 1.

Though second insulating coating layers are provided among all facing segment coils in coil end portions E1 and E2 in the present embodiment, second insulating coating layers can also be provided only in a portion where segment coils belonging to different phases great in voltage difference face each other. Thus, a region where a second insulating coating layer is provided can further be reduced. Since a second insulating coating layer is provided between segment coils belonging to different phases where partial discharge is likely, partial discharge can more effectively be prevented.

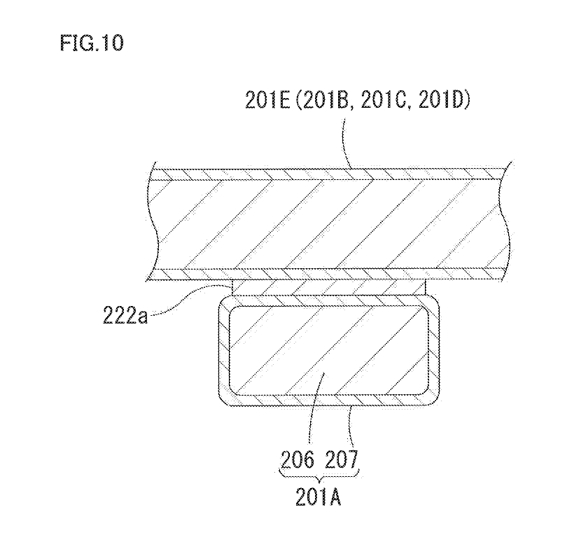

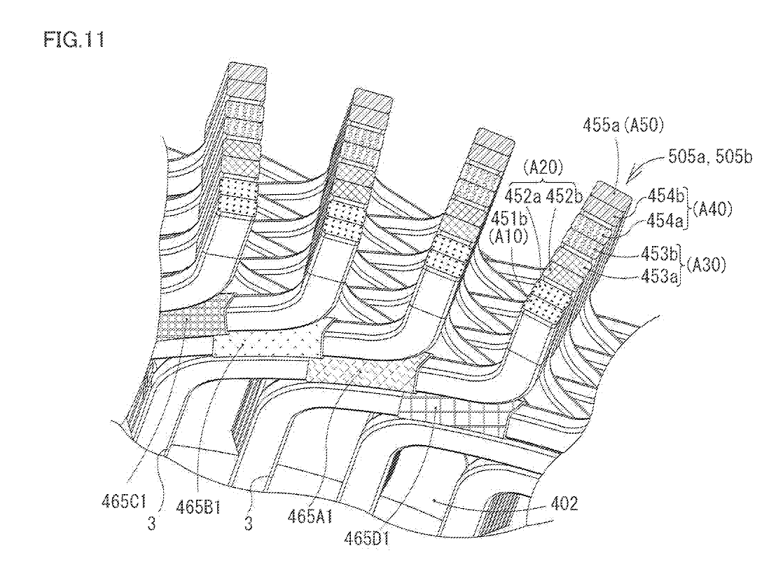

Though second insulating coating layers 212a to 212d are provided to surround a perimeter of one segment coil 201A with a prescribed width in the embodiment shown in FIG. 9, they can be provided only in a surface where other segment coils 201B to 201E face segment coil 201A. For example, as shown in FIG. 10, in one segment coil 201A, a second insulating coating layer 222a can be formed only on inner and outer surfaces in the direction of radius of the stator where other segment coils 201B to 201E face segment coil 201A. By adopting this construction, a region where a second insulating coating layer is to be provided can further be reduced.

Though second insulating coating layers 212a to 212d are formed of an insulating resin paint material in the present embodiment, limitation thereto is not intended. For example, second insulating coating layers 212a to 212d can be formed of an insulating resin tube material. For example, a heat-shrinkable tube material such as an insulating resin tube material (trade name Sumitube) manufactured by Sumitomo Electric Industries, Ltd. can be adopted as the insulating resin tube material.

Alternatively, second insulating coating layers 212a to 212d can be formed of an insulating resin tape material. For example, an insulating resin tape material (trade name Kapton tape) manufactured by Permacel can be adopted.

An area where a second insulating coating layer is to be provided is not particularly limited either. Though second insulating coating layers 212a to 212d are formed only in a portion in one oblique side portion 210a of one segment coil 201A which other segment coils 201B to 201D face in the present embodiment, they can also be formed in entire one oblique side portion 210a.

Each of segment coils 201A to 201E is formed by bending in advance a conductor having a large cross-sectional area. When a second insulating coating layer is provided at a site of bending before bending, crack or peel-off may take place in the second insulating coating layer and insulation may lower. Even after bending, it may be difficult to provide a second insulating coating layer at a bent site. For example, it is difficult to form a second insulating coating layer in a bent portion with the use of a tape material or a tube material. Therefore, in forming a second insulating coating layer of a film material or a tube material, a second insulating coating layer is preferably provided in a portion which is not bent.

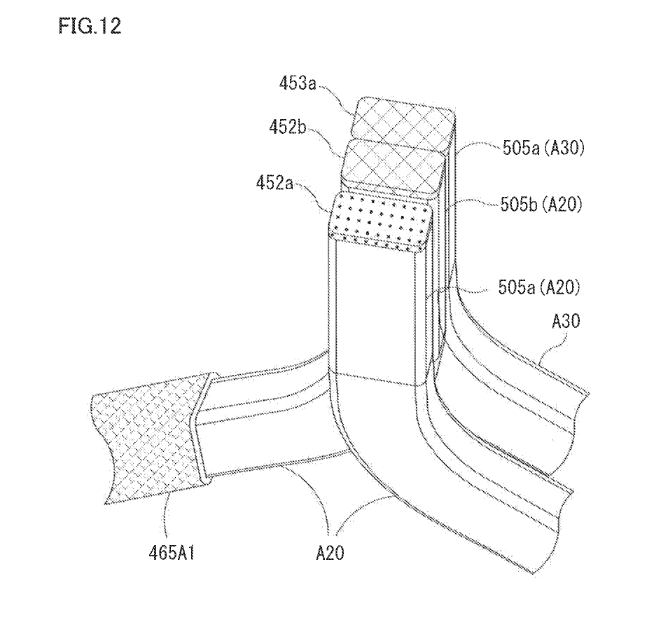

FIGS. 11 to 15 show a third embodiment of the invention of the present application. In the present embodiment as well, a segment coil attached on an innermost circumferential side in the direction of radius of the slot and opposed to the rotor is formed from a plurality of divided wires as divided in the circumferential direction of the annular core.

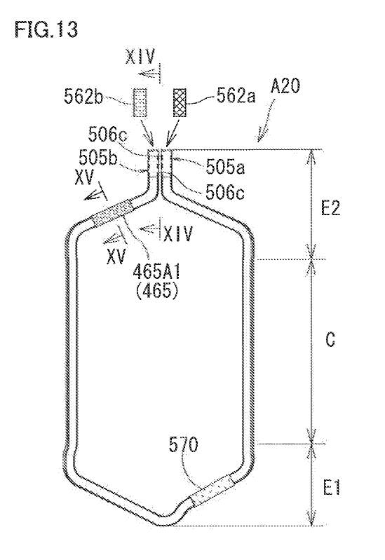

As shown in FIG. 11, first colored identification portions 451b, 452a, 452b, 453a, 453b, 454a, 454b, and 455a allowing identification of connection portions 505a and 505b of a series of connected segment coils A10 to A50 are provided. Basically, in segment coils A20 to A40 located in an intermediate portion, straight portions C shown in FIG. 13 are attached to the same slot. At least one of segment coil A10 arranged on the innermost side in the direction of radius of the stator and segment coil A50 arranged on the outermost side in the direction of radius of the stator is connected to a coil end portion extending from a straight portion attached to another slot.

First colored identification portions 451b, 452a, 452b, 453a, 453b, 454a, 454b, and 455a according to the present embodiment are formed by forming coil end surfaces of connection portions 505a and 505b of segment coils A10 to A50 to be flat and applying color paints to these flat surfaces.

First colored identification portions 451b, 452a, 452b, 453a, 453b, 454a, 454b, and 455a are obtained by applying a paint of the same color to connection portions connected to each other. The embodiment is drawn such that the same pattern has the same color. Namely, as shown in FIG. 11, colored identification portion 452b formed in segment coil A20 and colored identification portion 453a formed in segment coil A30 are in the same color. Similarly, as shown in FIG. 11, colored identification portion 451b and colored identification portion 452a, colored identification portion 453b and colored identification portion 454a, and colored identification portion 454b and colored identification portion 455a are different in color for each set. Therefore, by connecting through welding or ultrasound, connection portions having the colored identification portion in the same color formed, a plurality of segment coils A 10 to A50 belonging to the same phase are connected to thereby form a series of coils.

End surfaces of connection portions 505a and 505b of segment coils are sites reliably visually recognized from outside of the stator. By providing a first colored identification portion on a coil end surface, a connection operation can be performed with connection portions 505a and 505b of segment coils to be connected to each other reliably being identified.

Since the colored identification portions of segment coils connected to each other are in the same color, whether or not segment coils in the same color are connected to each other can also automatically be determined by observing end surfaces of the connection portions with an image recognition apparatus after connection. Therefore, not only an operation for assembling a stator but also a checking operation can extremely efficiently be performed.

A technique for forming a colored identification portion is not particularly limited. For example, first colored identification portions 451b, 452a, 452b, 453a, 453b, 454a, 454b, and 455a can be formed by applying color paints.

In the present embodiment, second colored identification portion 465A1, 465B1, 465C1, 465D1 for identifying a segment coil assembled in each slot 3 is provided in one oblique side portion of coil end portion E2 of each of segment coils A10 to A50. Second colored identification portions 465A1, 465B1, 465C1, and 465D1 are obtained by providing colored layers having the same color in segment coils A10 to A40 accommodated in the same slot.

By providing second colored identification portions 465A1, 465B1, 465C1, and 465D1, a prescribed segment coil can readily be attached to a prescribed slot.

In the present embodiment, as shown in FIG. 13, a second colored identification portion 570 for disposition identification which allows identification of an order of disposition of segment coils accommodated in the same slot is provided.

Second colored identification portion 570 for disposition identification is provided independently in coil end portion E1 opposite to coil end portion E2 where second colored identification portion 465A1, 465B1, 465C1, 465D1 for slot identification is provided. Second color identification portion 570 for disposition identification can be formed, for example, by providing coloring in the same color and different in density in accordance with an order of disposition. After assembly, colored identification portions different in color can appear alternately in segment coils attached to the same slot.

By providing second colored identification portion 570 for disposition identification, an assembly operation can be performed, with an order of assembly (disposition) of segment coils assembled into each slot being readily identified.

A construction and a form of second colored identification portions 465A1, 465B1, 465C1, and 465D1 are not particularly limited. For example, as shown in FIG. 15, as in the first embodiment, second colored identification portion 465A1 can be formed by applying a paint having a corresponding color to a prescribed region on an insulating coating 408 provided in a conductor 407.

The second colored identification portion can be obtained by bonding a color tape material or attaching a color tube material to a prescribed region in a segment coil. For example, an insulating resin tape material (trade name Kapton tape) manufactured by Permacel can be adopted as the color tape material. A heat-shrinkable tube material such as an insulating resin tube (trade name Sumitube) manufactured by Sumitomo Electric Industries, Ltd. can be adopted as the color tube material. By adopting an insulating paint or tape material or tube material, the second colored identification portion can function as a second insulating coating layer. Thus, not only an operation for assembly or an operation for connection of segment coils can readily be performed but also partial discharge between adjacent segment coils can effectively be prevented.

FIG. 13 shows a second variation in connection with the first colored identification portion. In the second variation, first colored identification portions 562a and 562b are implemented by providing color caps in connection portions 505a and 505b.

Since connection portions 505a and 505b are formed by removing an insulating coating layer, oxidation of a conductor surface or adhesion of grease thereto is likely during handling or storage. By providing a color cap, the exposed conductor surface can be protected.

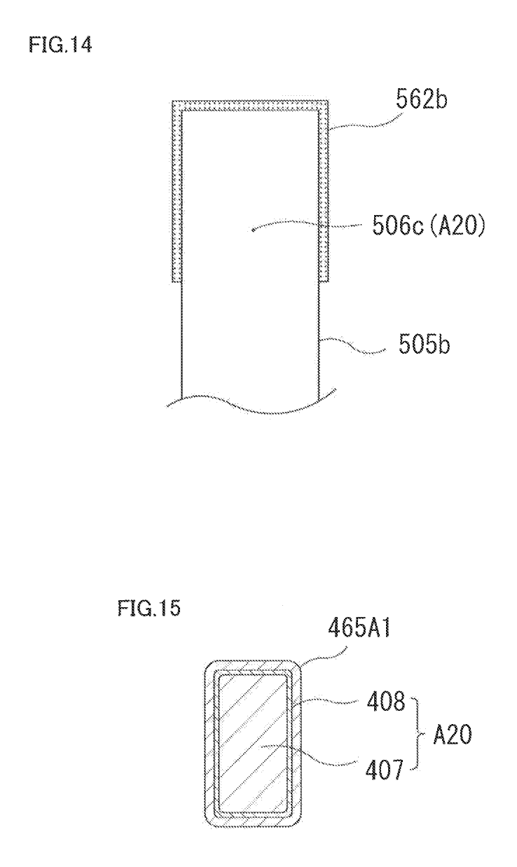

As shown in FIG. 14, the color cap according to the present embodiment is formed from a resin molded product in a form covering a surface except for a connection surface 506c. By adopting such a construction, connection can be made while color caps 562a and 562b remain attached.

A material forming the color cap is not particularly limited and a color cap molded from a colored resin material or a color cap formed from a metal material followed by coloring can be adopted.

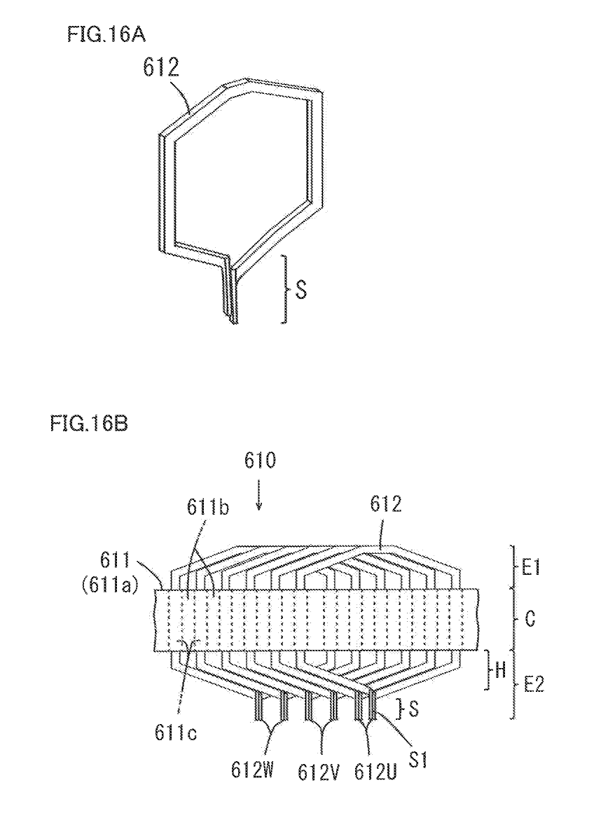

FIGS. 16A and 16B to 19 show a fourth embodiment of the invention of the present application. Since the embodiment is similar to the embodiments described above other than a joint portion of a coil end portion, description will not be provided.

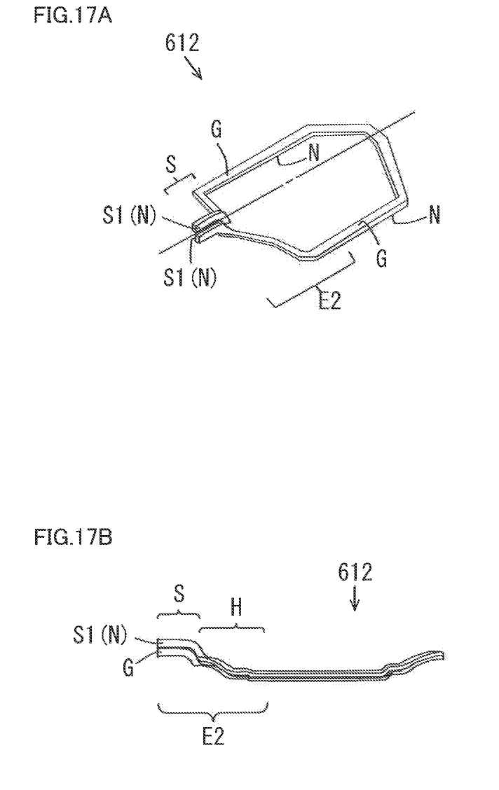

As shown in FIG. 16B, a segment coil 612 mainly includes a pair of linear straight portions C accommodated in a slot 611c and a pair of coil end portions E1 and E2 protruding outward of slot 611c. A joint portion S having a joint surface S1 for joining adjacent segment coils 612 in the same phase is provided at a tip end of one E2 (on a lower side in the figure in the present embodiment) of a pair of coil end portions E1 and E2. More specifically, as shown in FIGS. 16B and 17, an end portion of coil end portion E2 is twisted (bent) outward in a direction of radius of annular core 611. Thus, such a pair of joint portions S that joint surface S thereof is in parallel to the direction of radius of annular core 611 is provided at the tip end of coil end portion E2.

As shown in FIGS. 17A and 17B, in segment coil 612 including an inner-diameter-side coil surface N and an outer-diameter-side coil surface G in the direction of radius of annular core 611, the pair of end portions of coil end portion E2 is twisted (bent) by 90 degrees outward in the direction of radius of annular core 611 such that inner-diameter-side coil surfaces N are both arranged on an inner side in the circumferential direction of annular core 611 in the pair of joint portions S (outer-diameter-side coil surfaces G are both arranged on an outer side in the circumferential direction of annular core 611 in the pair of joint portions S). Thus, the pair of joint portions provided to protrude outward in the direction of radius of annular core 611 is formed. Namely, the pair of joint portions S is formed by twisting (bending) the pair of end portions of coil end portion E2 by 90 degrees in the same direction (foreign news in the direction of radius of annular core 611). In the present embodiment, as shown in FIG. 17A, inner-diameter-side coil surface N in the pair of joint portions S is defined as joint surface S1 for joint to another segment coil.

In the present embodiment, as shown in FIGS. 16A, 16B, 17A, and 17B, when segment coils 612 are arranged as aligned in slot 611c of annular core 611, adjacent joint portions S (a pair of joint portions S included in the same segment coil 612) are arranged as displaced between an inner diameter side and an outer diameter side in the direction of radius of annular core 611. Displacement in this pair of joint portions S is caused in such a manner that a portion of a coil in the vicinity of an end portion except for joint portion S on any one side of a centerline (a chain dotted line) shown in FIG. 17A is bent inward or outward in the direction of radius of annular core 611, so as to form a difference in level in the direction of radius of annular core 611 in the coil end portion.

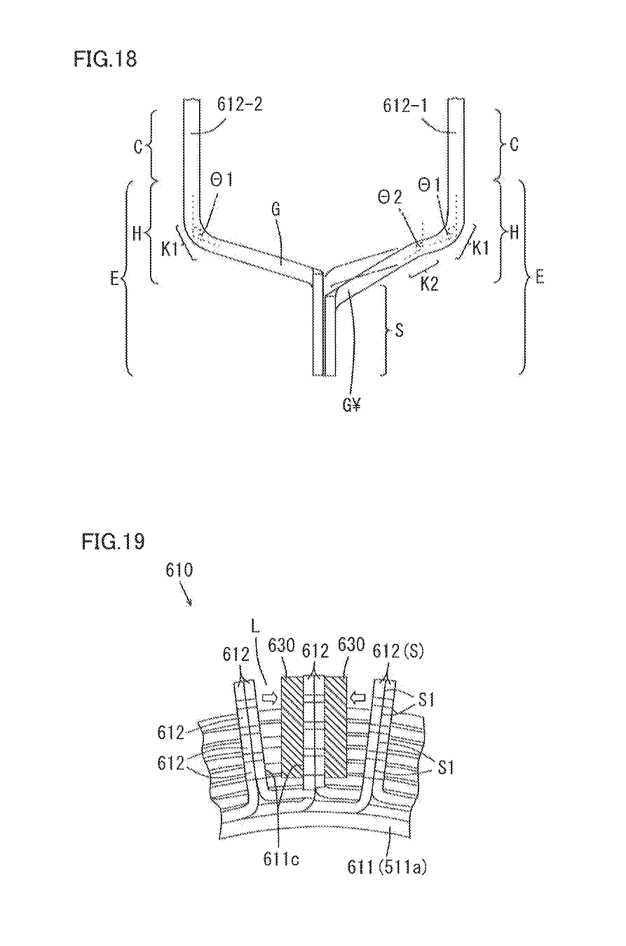

In the present embodiment, as shown in FIG. 16B, in segment coil 612, an extension portion H extending from straight portion C to joint portion S is bent at one or a plurality of location(s) inward in the circumferential direction of annular core 611. More specifically, as shown in FIG. 18, extension portion H is bent inward in the circumferential direction of an inner-diameter-side coil 612-1 arranged on an inner diameter side in the direction of radius of annular core 611. In an outer-diameter-side coil 612-2, extension portion H is bent inward in the circumferential direction of annular core 611 at one location of a first bent region K1.

An angle of bending of a coil in first bent region K1 in inner-diameter-side coil 612-1 and in first bent region K1 in outer-diameter-side coil 612-2 is set to the same angle θ1. In addition, in inner-diameter-side coil 612-1, an angle θ2 representing an angle of bending of the coil in a second bent region K2 is greater than angle θ1 representing an angle of bending of the coil in first bent region K1. Desirably, angle θ1 is approximately from 95 degrees to 150 degrees and more preferably approximately from 105 degrees to 125 degrees. When the angle is smaller than 95 degrees, coils interfere with each other in coil end portions E1 and 2 and they cannot be disposed. When the angle exceeds 150 degrees, a dead space between a core end surface and a coil becomes large and a dimension in a direction of length of a motor shaft increases. Desirably, angle θ2 is approximately from 100 degrees to 160 degrees and more preferably approximately from 110 degrees to 130 degrees. When the angle is smaller than 100 degrees, interference with the other end portion of the same coil is likely. When the angle exceeds 160 degrees, a length of joint at a tip end of a coil is short.

It is noted that welding such as resistance welding or solid-phase welding such as ultrasonic welding and cold welding can be employed as a method of joining joint portions S. In the present embodiment, joint portions S to mutually be joined are joined through ultrasonic welding representing solid-phase welding.

Joint portion S is constructed such that joint surface S1 thereof is in parallel to the direction of radius of annular core 611, by twisting an end portion of coil end portion E2. Thus, as shown in FIG. 19, when a plurality of segment coils 612 are arranged as aligned in annular core 611, a direction of pressurization of joint portion S can be set to the circumferential direction of annular core 611 (a direction shown with a hollow arrow in FIG. 19). Therefore, a space L (a gap) formed between adjacent slots 611c can effectively be made use of for joint of joint portions S. Therefore, a sufficient space can be secured in the direction of pressurization of joint portion S and operability in the step of joining joint portions S can be improved. More specifically, bringing or taking a jig for joint 630 (in the present embodiment, an ultrasonic jig) into or out of space L formed between adjacent slots 611c can be facilitated or accuracy in holding joint portions S to mutually be joined can be improved. Therefore, adjacent segment coils 612 can efficiently be joined to each other.

By setting joint surface S1 of joint portion S to be in parallel to the direction of radius of annular core 611, when a plurality of segment coils 612 are arranged as aligned in annular core 611, space L (gap) formed between adjacent slots 611c can effectively be increased. Therefore, a stator and a motor can have a good heat dissipation property.

When segment coils 612 are arranged as aligned in slots 611c of annular core 611, adjacent joint portions S (a pair of joint portions S included in the same segment coil 612) are arranged as displaced between the inner diameter side and the outer diameter side in the direction of radius of annular core 611. Thus, as shown in FIG. 19, simply by arranging a plurality of segment coils 612 as aligned in annular core 11, joint surfaces S1 of joint portions S to mutually be joined, of a plurality of segment coils 612 arranged in the same slot 611c, can be arranged as opposed to each other.

In addition, by setting joint surface S1 to be in parallel to the direction of radius of annular core 611, as shown in FIG. 19, joint surfaces S1 of a plurality of sets of joint portions S to mutually be joined can be arranged in a line in the direction of radius of annular core 611. Additionally, as described already, space L (gap) formed between adjacent slots 611c can effectively be made use of for joint of joint portions S. Therefore, a plurality of sets of joint portions S to mutually be joined can simultaneously (together) be pinched by jig for joint 630 and joint of the plurality of sets of joint portions S can simultaneously be achieved. Namely, multi-point simultaneous joint of the plurality of sets of joint portions S can be achieved. Thus, operability in the step of joining joint portions S can further effectively be improved. A stator and a motor can be high in manufacturing efficiency.

As shown in FIG. 18, in inner-diameter-side coil 612-1, extension portion H is bent inward in the circumferential direction of annular core 611 at two locations of first bent region K1 and second bent region K2, and in outer-diameter-side coil 612-2, extension portion H is bent inward in the circumferential direction of annular core 611 at one location of first bent region K1. In addition, an angle of bending of the coil in first bent region K1 in inner-diameter-side coil 612-1 and an angle of bending of the coil in first bent region K1 in outer-diameter-side coil 612-2 are both set to angle θ1, and in inner-diameter-side coil 612-1, angle θ2 is set to be greater than angle θ1. Thus, as shown in FIG. 18, joint portion S of inner-diameter-side coil 612-1 and joint portion S of outer-diameter-side coil 612-2 are displaced from each other in the axial direction of annular core 611.

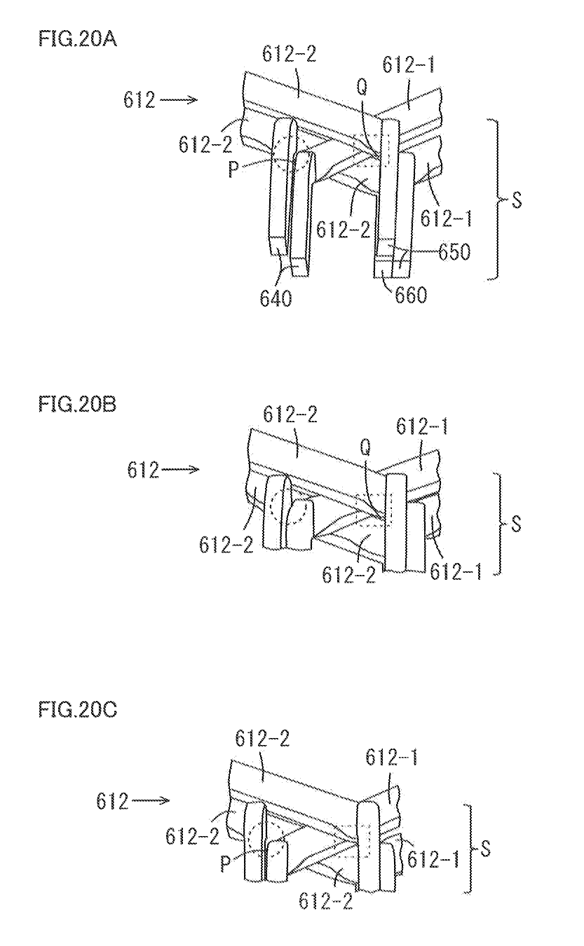

Namely, since inner-diameter-side coil 612-1 and outer-diameter-side coil 612-2 are bent inward in the circumferential direction, essentially, as shown with a virtual line (a chain dotted line) in FIG. 18, joint portion S of inner-diameter-side coil 612-1 and joint portion S of outer-diameter-side coil 612-2 are not displaced from each other in the axial direction of annular core 611. By further bending inner-diameter-side coil 612-1 at angle θ2, joint portion S of inner-diameter-side coil 612-1 can be arranged below the joint portion of outer-diameter-side coil 612-2 in the axial direction of annular core 611. Therefore, when a plurality of segment coils 612 are arranged as aligned in annular core 611, as shown in FIG. 20A, initially, a space P (gap) can be formed in a pair of joint portions S (a portion shown with a dashed circle in FIG. 20A) in the same segment coil 612. Therefore, contact in the pair of joint portions S can be prevented.

Additionally, segment coils 12 arranged in adjacent slots 611c (a portion shown with a dashed quadrangle in FIG. 20A can be prevented. More specifically, while a first segment coil 640, a second segment coil 650, and a third segment coil 660 (inner-diameter-side coil 612-1 not shown) are arranged, contact between inner-diameter-side coil 612-1 of first segment coil 640 and outer-diameter-side coil 612-2 of third segment coil 660 can effectively be prevented.

It is noted that FIGS. 20A and 20B show that second segment coil 650 and third segment coil 660 are arranged in the same slot (not shown) and inner-diameter-side coil 612-1 of second segment coil 650 and outer-diameter-side coil 612-2 of third segment coil 660 are ultrasonically mutually bonded. First segment coil 640 is assumed to show segment coil 612 which is arranged in slot 611c next to slot 611c where second segment coil 650 and third segment coil 660 are arranged.

As in a first comparative example shown in FIG. 20B, when angle θ1 (shown in FIG. 18) is smaller than in the present embodiment in inner-diameter-side coil 612-1, a space Q can be formed between segment coils 612 (a portion shown with a dashed quadrangle in FIG. 20B) arranged in adjacent slots 611c, whereas space P cannot be formed in the pair of joint portions S (a portion shown with a dashed circle in FIG. 20B) in the same segment coil 612. Therefore, paired joint portions S come in contact with each other.

As in a second comparative example shown in FIG. 20C, when angle θ1 (shown in FIG. 18) is greater than in the present embodiment in inner-diameter-side coil 612-1, space P can be formed in the pair of joint portions S (a portion shown with a dashed circle in FIG. 20C) in the same segment coil 612, whereas space Q cannot be formed between segment coils 612 (a portion shown with a dashed quadrangle in FIG. 20C) arranged in adjacent slots 611c. Therefore, segment coils 612 arranged in adjacent slots 611c come in contact with each other.

According to the present embodiment, space P and space Q can simultaneously be formed in the pair of joint portions S in the same segment coil 612 and between segment coils 612 arranged in adjacent slots 611c, respectively. Namely, contact of coil between segment coils 612 arranged in adjacent slots 61c can be avoided owing to angle θ1, and contact of coil in the pair of joint portions S in the same segment coil 612 can be avoided owing to angle θ2.

Therefore, when a plurality of segment coils 612 are arranged as aligned in annular core 611, contact between segment coils 612 arranged in adjacent slots 611c and in the pair of joint portions S in the same segment coil 612 can be prevented. In addition, by forming a crank portion in coil end portion E opposite to joint portion S, contact between segment coils 612 accommodated in adjacent slots 611c can also be avoided in coil end portion E opposite to joint portion S. Therefore, a stator and a motor can be high in electrical connection reliability.

By joining joint portions S to mutually be joined through ultrasonic welding representing solid-phase welding, a time period for operation for the joint step can be shortened and a stator and a motor can be higher in manufacturing efficiency. By employing solid-phase welding, thermal influence is less, and a conductor or a film material low in heat resistance and inexpensive can be employed.

By joining joint portions S through ultrasonic welding representing solid-phase welding, a time period for operation for the joint step can be shortened and a method of manufacturing a stator and a motor high in manufacturing efficiency can be obtained. By employing tough pitch copper for elemental wire R forming segment coil 612, segment coil 612 can be excellent in electrical conductivity and thermal conductivity as well as good in workability. Therefore, a stator and a motor high in electrical connection reliability can be manufactured and higher efficiency in a manufacturing process can be obtained.

A difference in level in a coil end portion is formed between the left and the right of the centerline (chain dotted line) shown in FIG. 17A by bending the coil in a portion except for joint portion S inward or outward in the direction of radius of annular core 611 to thereby cause displacement in the pair of joint portions S in the direction of radius of annular core 611 in the present embodiment. A method of causing displacement in the pair of joint portions S in the direction of radius of annular core 611, however, is not necessarily limited as such. For example, displacement may be caused in the pair of joint portions S in the radial direction of annular core 611 by differing a direction of twist (a direction of bending) of the pair of joint portions S without forming a difference in level in a coil end portion in the direction of radius of annular core 611 between the left and the right of the centerline (chain dotted line) shown in FIG. 17A.

The number of times of bending, a position of bending, and an angle of bending inward in the circumferential direction of annular core 611 in inner-diameter-side coil 612-1 and outer-diameter-side coil 612-2 are not limited to those in the present embodiment either and can be changed as appropriate so long as contact of coil in the pair of joint portions S in the same segment coil 612 and between coil end portions E2 of segment coils 612 arranged in adjacent slots 611c in a case that a plurality of segment coils 612 are arranged as aligned in annular core 611 can be prevented.

Though joint portions S to mutually be joined are joined through ultrasonic welding representing solid-phase welding in the present embodiment, limitation thereto is not necessarily intended. For example, other solid-phase welding such as cold welding or welding such as resistance welding can be employed for mutual joint. The number of segment coils 612 forming the U-phase, the V-phase, and the W-phase, a shape of segment coil 612, a shape of annular core 611, or a construction of a motor is not limited to that in the present embodiment and can be changed as appropriate.

Though an insulating coating layer forming step is performed after a coil element forming step in the embodiment of the present invention, limitation thereto is not necessarily intended. For example, elemental wire R is prepared, a first insulating coating layer forming step is initially performed, thereafter the coil element forming step is performed, and a second insulating coating layer forming step can further subsequently be performed. Thus, an insulating material which is in good balance between insulation performance and cost can be selected.

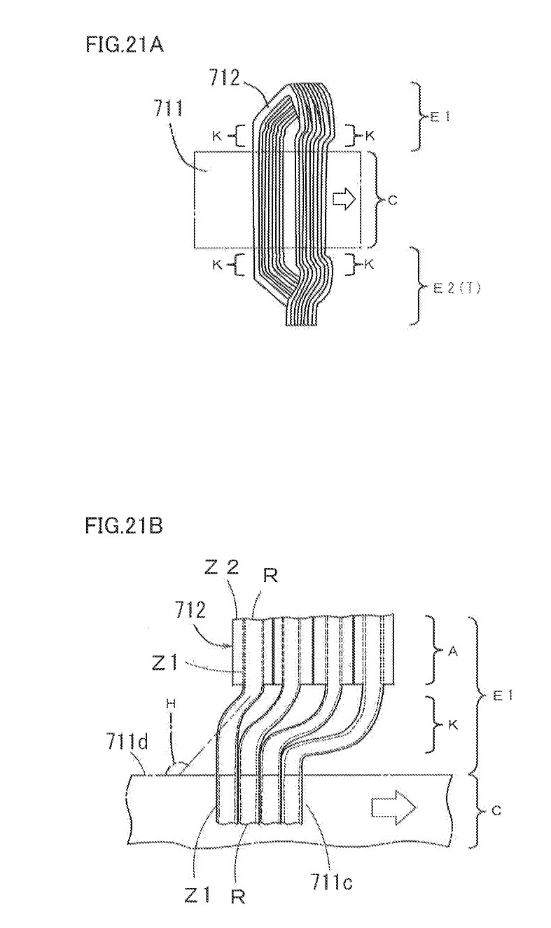

FIGS. 21A and 21B show a fifth embodiment of the present application. In the present embodiment, as shown in FIG. 21A, in a region of a pair of coil end portions E2 except for a thick region A which will be described later, an inclined region K inclined outward in the direction of radius of an annular core 711 is provided. It is noted that a direction shown with a hollow arrow indicates outward in the direction of radius in FIGS. 21A and 21B.

Specifically, segment coils arranged adjacently in the same slot of a stator are inclined in the direction of radius in inclined region K extending from the slot to where it is bent in a circumferential direction toward the peak portion of the coil end portion, so that a second insulating coating layer Z2 provided in the coil end portion of the segment coil is brought in contact in the direction of radius of the stator. The second insulating coating layer is formed such that a distance between coils in the direction of radius of the stator at a portion of contact is greater than a distance between coils in the slot. The “distance between coils” here means a distance between centers of coils in a direction of radius of an annular core.

As shown in FIG. 21B, inclined region K is set within an area in coil end portions E1 and E2 approximately 500 μm to 5 mm from an end surface 711d of annular core 711 in an axial direction of annular core 711. As shown in FIG. 21B, an angle of inclination means an angle H formed between segment coil 712 forming inclined region K and end surface 711d of annular core 711.

In the present embodiment, a thickness of an insulating coating layer in segment coil 712 is different between straight portion C and coil end portions E1 and E2. More specifically, in straight portion C, an insulating coating layer is formed by covering the surface of elemental wire R only with a first insulating coating layer Z1. In contrast, in a prescribed region in a region except for inclined region K in coil end portions E1 and E2, thick region A is formed by covering the surface of elemental wire R with first insulating coating layer Z1 and covering the surface of first insulating coating layer Z1 further with second insulating coating layer Z2. It is noted that the “prescribed region” here means a region of “coil end portion E including a site where insulating coating layers of adjacent segment coils 612 are brought in contact with each other. FIG. 21B illustrates thick region A as exaggerated for the sake of convenience of illustration.

Any elemental wire R may be employed so long as it is a normally used elemental wire forming a coil, for example, of copper.

Polyamide imide or polyimide can be employed as a material for first insulating coating layer Z1. A thickness of first insulating coating layer Z1 should only comply with a design voltage between coil turns. For example, when a design voltage is 500 V, desirably, a thickness is approximately from 15 μm to 30 μm and more suitably approximately from 15 μm to 25 μm. When a thickness is smaller than 15 μm, probability of deterioration of a film due to partial discharge or occurrence of pin holes during manufacturing increases. When a thickness exceeds 25 μm, lowering in assembly performance due to increase in heat generation or increase in outer diameter caused by lowering in space factor in slot 611c is caused. Pulling through a die or electrodeposition can be employed as a formation method. It is noted that first insulating coating layer Z1 for straight portion C and coil end portions E1 and E2 can integrally be formed in the same step.

A super engineering plastic material represented by polyamide imide or polyimide or a material in which an inorganic filler is mixed in engineering plastic can be used as a material for second insulating coating layer Z2. Pulling through a die, electrodeposition, powder coating, adhesion of a tape, dipping, spray coating, insert injection molding, or extrusion can be employed as a formation method.

Since a peak voltage approximately twice as high as an input voltage is applied as a voltage between motor phases due to influence by inverter surge, for example, when a design voltage is 1000 V, desirably, a thickness of second insulating coating layer Z2 is approximately from 40 μm to 200 μm and more preferably approximately from 80 μm to 120 μm. When a thickness is smaller than 40 μm, a film is deteriorated due to partial discharge. When a thickness exceeds 200 μm, a dimension due to increase in conductor spacing at a coil end increases.

By adopting the construction above, segment coils 712 arranged adjacently in the same slot can effectively be brought in close contact between straight portions C and between coil end portions E1, E2. In particular, in the present embodiment, in adjacent segment coils 712 arranged in the same slot, first insulating coating layer Z1 for straight portion C and second insulating coating layer Z2 forming thick region A of coil end portions E1 and E2 are brought in close contact without a gap. Thus, a high space factor in a slot can be achieved and the number of turns of a coil in the slot can be increased.

Corona discharge between coils is likely in a region where a gap between adjacent segment coils is small. In the present embodiment, particularly, corona discharge between adjacent segment coils 712 of the same phase can effectively be prevented. Thus, a stator capable of maintaining good insulation, which allows effective prevention of deterioration of insulating coating layers Z1 and 72 involved with corona discharge between adjacent segment coils 712 of the same phase, can be obtained.

Angle of inclination H of segment coil 712 and a length of segment coil 712 may each be different. In forming a stator, in adjacent segment coils 712 arranged in the same slot 711c, angle of inclination H of a coil in region K should be such that an angle of inclination of segment coil 712 arranged on the outer circumferential side of annular core 711 is greater than an angle of inclination of segment coil 712 arranged on the inner circumferential side of annular core 711 and a length of region K should be such that a length of segment coil 712 arranged on the outer circumferential side of annular core 711 is longer than a length of segment coil 712 arranged on the inner circumferential side of annular core 711.

Though all adjacent segment coils 712 in the same slot are in contact in the direction of radius of the annular core in straight portion C and in thick region A of coil end portions E1 and E2 in the present variation, limitation thereto is not necessarily intended, and the construction can be changed as appropriate so long as at least one set of adjacent segment coils 712 arranged in the same slot are in contact in the direction of radius of the annular core in straight portion C and in thick region A of coil end portions E1 and E2.

The scope of the invention of the present application is not limited to the embodiments described above. It should be understood that the embodiments disclosed herein are illustrative and non-restrictive in every respect. The scope of the invention of the present application is defined by the terms of the claims, rather than the meaning described above, and is intended to include any modifications within the scope and meaning equivalent to the terms of the claims.

### INDUSTRIAL APPLICABILITY

Eddy current or magnetic flux leakage can be mitigated, a space factor of a coil is enhanced, and efficiency of a motor can be improved.

### REFERENCE SIGNS LIST

1 stator; 2 annular core; 3 slot; 4a segment coil; 5a segment coil; 11 divided wire; 12 divided wire; 13 divided wire; E1 coil end portion; and E2 coil end portion.

1. A segment coil in a stator of a rotating electric machine including an annular core and rectangular wire coils of a plurality of layers, which is attached on an innermost circumferential side in a direction of radius of a slot formed in an inner circumferential portion of the annular core and opposed to a rotor, comprising:
a plurality of divided wires as divided in a circumferential direction of the annular core, the plurality of divided wires being integrally joined in a coil end portion extending from the slot.

2. The segment coil according to claim 1, wherein
each of the plurality of divided wires has a rectangular cross-section having a side opposed to the rotor as a short side.

3. The segment coil according to claim 1, wherein
an inner-circumferential-side divided wire including at least a divided wire arranged on the innermost circumferential side with respect to a tooth portion around which the segment coil is wound when viewed from a center in the direction of radius of the stator is formed of a material higher in resistivity than a divided wire arranged on an outer circumferential side.

4. The segment coil according to claim 1, wherein
the plurality of divided wires are integrally joined with an insulating resin material.

5. The segment coil according to claim 4, wherein
the insulating resin material is an insulating adhesive, an insulating resin tape material, or an insulating resin tube material.

6. The segment coil according to claim 1, wherein
the coil end portion is formed in a mountain shape, and
the plurality of divided wires are joined in an oblique side portion except for a portion near a peak portion of the mountain shape and portions near opposing mountain-foot portions and/or in a straight portion extending from the slot.

7. The segment coil according to claim 1, comprising:
a first insulating coating layer formed substantially in an entire region of the segment coil; and
a second insulating coating layer formed as stacked at a prescribed site of the first insulating coating layer, wherein
the second insulating coating layer is provided in a portion where segment coils belonging to different phases face each other.

8. The segment coil according to claim 7, wherein
the second insulating coating layer is formed on an inner surface and/or an outer surface in the direction of radius of the stator in the segment coil.

9. The segment coil according to claim 7, wherein
an insulating resin material joining the divided wires to each other implements the second insulating coating layer.

10. The segment coil according to claim 7, wherein
the coil end portion extending from the slot is formed substantially in a mountain shape having a central portion as a vertex, and
in one oblique side portion of the substantial mountain shape of the segment coil, a second insulating coating layer facing the other oblique side portion of a segment coil arranged adjacently to the segment coil is formed.

11. The segment coil according to claim 1, wherein
a colored identification portion is provided on a surface in a prescribed region.

12. The segment coil according to claim 11, wherein
a first colored identification portion allowing identification of a connection portion of the segment coil to be connected is provided in the connection portion or a portion near the connection portion.

13. The segment coil according to claim 12, wherein
the first colored identification portion is formed on a coil end surface of the connection portion.

14. The segment coil according to claim 12, wherein
the first colored identification portion is provided by applying a color paint or bonding a color tape material.

15. The segment coil according to claim 12, wherein
the first colored identification portion is provided by providing a color cap in a coil end portion.

16. The segment coil according to claim 11, comprising a second colored identification portion provided on a surface other than the connection portion and formed to allow identification of a slot where each segment coil is attached and/or a position of disposition in the slot.

17. The segment coil according to claim 16, wherein
the second colored identification portion is provided by applying a color paint, bonding a color tape material, or attaching a color tube material to a prescribed region of the segment coil.

18. The segment coil according to claim 16, wherein
the second colored identification portion implements a second insulating coating layer preventing partial discharge against an adjacently arranged segment coil.

19. The segment coil according to claim 1, comprising a connection portion having a joint surface for connection to another segment coil provided at a tip end portion of the segment coil, wherein
the connection portion is constructed such that the joint surface is in parallel to the direction of radius of the stator.

20. The segment coil according to claim 19, wherein
the connection portion is formed such that the joint surface is in parallel to the direction of radius of the annular core by twisting an end portion.

21. The segment coil according to claim 19, comprising a pair of connection portions arranged at prescribed positions in the circumferential direction of the stator, wherein
the pair of connection portions is constructed such that adjacent connection portions are arranged as displaced between an inner diameter side and an outer diameter side in the direction of radius of the annular core when segment coils are arranged as aligned in the slots of the annular core.

22. A method of manufacturing a segment coil which is attached on an innermost side in a direction of radius of a slot provided in an annular core and opposed to a rotor and is formed by joining a plurality of divided wires as divided in a circumferential direction of the annular core, comprising:
a bundling step of bundling a plurality of elemental wires implementing the divided wires with a tape material or a tube material at a site of formation of a coil end portion; and
a bending step of integrally bending the integrated elemental wires at a site other than a site of joint.

23. The method of manufacturing a segment coil according to claim 22, wherein
the segment coil formed from the divided wires is joined with the tape material or the tube material.

24. The method of manufacturing a segment coil according to claim 22, comprising a joint step of joining the divided wires with an adhesive in the coil end portion after the bending step.

25. A wire rod for a segment coil attached on an innermost side in a direction of radius of a slot provided in an annular core and opposed to a rotor and formed by joining a plurality of divided wires as divided in a circumferential direction of the annular core,
the plurality of divided wires being integrally joined with an insulating resin material in a portion to serve as a coil end portion.

26. The wire rod for a segment coil according to claim 25, wherein
the insulating resin material is an insulating adhesive, an insulating resin tape material, or an insulating resin tube material.

27. The wire rod for a segment coil according to claim 25, comprising an insulating coating layer around an outer perimeter except for connection portions provided in opposing end portions, wherein
a colored identification portion is provided on an end surface of the wire rod in the connection portion and/or on a surface of a prescribed region of the insulating coating layer.

28. A stator comprising the segment coils according to claim 1.

29. The stator according to claim 28, wherein
joint portions of adjacent segment coils are solid-phase bonded.

30. The stator according to claim 28, wherein
an insulating coating layer is formed such that the insulating coating layer provided in a coil end portion of the segment coil is brought in contact in a direction of radius of the stator and a distance between coils in the direction of radius of the stator in a portion of contact is greater than a distance between coils in a slot by inclining at least one set of segment coils arranged adjacently in a common slot in the direction of radius in a region extending from the slot to a portion where it is bent in a circumferential direction toward a peak portion of the coil end portion.
